(19) United States
(12) Patent Application Publication
(10) Pub. No.: US 2006/0224399 A1
(43) Pub. Date: Oct. 5, 2006

(54) Method and system for decision making based on information requirements

(75) Inventors: Jens Alkemper, Schenectady, NY (US); Kunter Seref Akbay, Niskayuna, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: General Electric Company

(21) Appl. No.: 11/096,406

(22) Filed: Mar. 31, 2005

(51) Int. Cl. G06Q 99/00

(52) U.S. Cl. 705/1

(57) ABSTRACT

A method is provided for decision making based on information requirements of a business system. The method includes reading a decision information matrix that includes at least one process step related to a process of the business system, input information requirements associated with each of the at least one process step. The method also includes processing a deal, the deal including a set of available information, comparing the available information associated with the deal to the input information requirements associated with the at least one process step, activating the at least one process step if the input information requirements associated with the at least one process step are included in the available information associated with the deal. The method further includes receiving output information from each of the at least one activated process step, adding the output information to the decision information matrix, evaluating if a final output information for the deal has been received, and continuing to compare and activate process steps as appropriate based on the available information.

### BACKGROUND

The present invention relates to a methodology for process planning and process design in business systems with an opportunity to derive functional workflows from information requirements.

Process planning and process design methodologies have existed in organizational theory for long time. Usually, a workflow is set up around the value chain of the core products or the core services of a business system and decision making follows that workflow closely. However, the majority of these traditional decision making methods have fallen short of achieving accuracy, flexibility and speed of execution under dynamic business scenarios. That raises a question of whether the traditional approach to make decisions around core product or service workflows has been effective for business decision making. The drawback of this approach, as is often pointed out, is that the exercise of decision making often ends up being insensitive to ever-changing dependencies of various input and output parameters of business processes.

While outlining business processes, information is being increasingly recognized as an organizational resource, fundamentally as important as the core products or the core services of a business system. Likewise, there is an increasingly perceived need for a shift away from analyzing decision making as merely an act of following a set of workflows designed to achieve the product or service goals of a business system. Accordingly, there is a need in the art to provide a more accurate, efficient and change adaptive method and system for decision making.

### BRIEF DESCRIPTION

Briefly, in accordance with one embodiment of the invention, a method is provided for decision making based on information requirements of a business system. The method includes reading a decision information matrix that includes at least one process step related to a process of the business system and input information requirements associated with each of the at least one process step. The method also includes processing a deal, the deal including a set of available information, comparing the available information associated with the deal to the input information requirements associated with the at least one process step, and activating the at least one process step if the input information requirements associated with the at least one process step are included in the available information associated with the deal. The method further includes receiving output information from each of the at least one activated process step, adding the output information to the set of available information, evaluating if a final output information for the deal has been received, and continuing to compare and activate process steps as appropriate based on the available information.

In accordance with another embodiment of the invention, a system is provided for decision making based on information requirements of a business system. The system includes a decision information matrix to capture and display the information requirements, at least one deal comprising a set of available information to be processed, and a controller to process the at least one deal based on the available information and the information requirements implicitly and generate at least one output information associated with the at least one deal.

### DRAWINGS

These and other features, aspects, and advantages of the present invention will become better understood when the following detailed description is read with reference to the accompanying drawings in which like characters represent like parts throughout the drawings, wherein:

FIG. 1 shows a decision information matrix (DIM) as is explained in accordance with an exemplary embodiment;

FIG. 2 shows a workflow generated from a decision information matrix as is explained in accordance with an exemplary embodiment;

FIG. 3 shows an updated workflow generated from a decision information matrix as is explained in accordance with an exemplary embodiment;

FIG. 4 shows an exemplary flow chart of a decision making process as is explained in an exemplary embodiment.

### DETAILED DESCRIPTION

In traditional business literature, a process is defined as a structured, measured set of activities designed to produce a specified output for a particular customer or market. In the same manner, a business process is a set of logically related tasks performed to achieve a defined business outcome or a goal. It implies a strong emphasis on how work is done within a business system. Business processes have two important characteristics. First, every business process is meant for a number of customers—internal or external. Second, every business process crosses organizational boundaries, i.e., it occurs across or between organizational subunits, functions or sub-functions. Business processes are generally identified in terms of a number of process steps where output of one step is utilized as the input of another step. Typically, organizational resources are the first set of inputs to the process steps and the finished products and services are the final outputs. In between, there are many organizational functions or sub-systems involved and also the interfaces between these functions or sub-systems. In fact, customers are often viewed as an extended part of a business system existing beyond an interface meant for exchange of products and services for their value. Some processes have high impact on the business goals of a business system. Conversely, other processes are rather customary in nature and low in impact.

Business processes are intended to deliver certain business goals and at times, these processes and the process steps come under organizational scrutiny. The motivation behind such a scrutiny can vary over a number of situations, for example, to capture all the existing dependencies of different process steps on each other. In other situations, the motivation may be simply an organization-wide desire to be able to make lean, fast, flexible and accurate decisions. The primary thrust of such scrutiny is to arrive at an actionable item and such an exercise is often followed by an action plan. In organizational parlance, such an action plan is typically known as a workflow. In order to serve its intended purpose, a workflow has to be accurate, effective and change adaptive and thereby helpful to a business system in achieving its business goals of correct decisions.

One of the central issues in management of business systems is thus how to identify different process steps and organize them into a coherent workflow so that resources are used optimally and converted effectively to the final products and services of the business system. One technique for identifying process steps in a business system is to follow the value chain of a core product or a core service that the business produces for consumption in the market. A value chain is a set of logical steps by which a low valued object or a raw material is converted into a high valued finished product or service.

In this context, it may be elaborated that an optimal configuration of resource use is one where resources are used in process steps that are arranged in a parallelized workflow. Present day process planning and process design exercises attempt to capture the details of information usage and information dependencies in a dynamic set up of the business systems and then generate a workflow that is automatically validated and parallelized. The final goal of an effective process plan and process design is to implement a parallelized workflow by operationalizing it. These steps will be elaborated in more details below.

Process planning and process design methodologies have existed in organizational theory for more than a decade. As mentioned above, typically a workflow is set up around the value chain of the core products or the core services of a business system and decision making follows that workflow closely. However, the majority of these traditional process planning and process design methods have fallen short of achieving accuracy, flexibility and speed of execution under dynamic business scenarios.

One embodiment of the present technique focuses on a method of managing information and its usage through a business system. Accordingly, a business system is to be built around the information and communication requirements of a business system instead of a process hierarchy or workflow based on a value chain of products or services. The questions that drive the design, survival, operation as well as excellence of any such business system are:
What information is needed to complete the organizational tasks?
From whom, when, and how can this information be generated and procured?
What information needs to be passed on through the value chain because decisions and thus other information is dependent on this information?
In what form and when can this transfer of information happen?

An information-centric model or its reference as outlined above, is applicable to any business system that operates in the business world of today's information age. These information-centric models are built around the technology, organizational culture or philosophy as well as the people of such business systems. The key to unleash the vast potential contained in any business system is to identify, connect and integrate different parts of a value chain of information that otherwise exist as isolated bodies of information. A business system enables itself to solve problems by building an environment where all the information resources are linked in an input and output relationship. The vision of a business system is realized through an ongoing collaboration of different entities when the information resources are linked by dependency. This can be achieved by having multiple data structures and matrices, all widely available and interacting together with clearly defined and shared definitions of data. The new way of doing business is to recognize information as a powerful resource and then to organize and/or distribute the information in order to parallelize that powerful resource as much as possible. In a modern business environment, information is easily parallelized as it can be shared and made available to anybody, anywhere, anytime. This way, everyone within a business system is empowered to work in a parallel flow of necessary resources and execute his task irrespective of the priorities or executables of others. Thus, an exercise of decision making in accordance with one embodiment, is essentially a process of organization of information usage.

A value chain of information can be compared with a traditional value chain of products or a value chain of services by comparing different physical and informational models of typical business systems. In a physical model, raw materials enter a business system and leave as finished goods. For example, in a manufacturing based business system, raw materials are converted into finished products of daily use at the end of their value chain. On the other hand, in an informational model like an internet-based electronic commerce or e-commerce system, information is value-added through different process steps.

Recorded facts related to organizational business systems are classified into four categories as commonly known in the art:

Data: Data is understood in terms of a number of symbols or alphabets or numbers.

Information: Information is data that are processed to be useful for providing answers to ‘who’, ‘what’, ‘where’, and ‘when’ questions in relation to operation of a business system.

Knowledge: Knowledge is the application of data and information to answer the ‘how’ questions in relation to operation of a business system.

Comprehension: Comprehension is appreciation of ‘why’ questions in relation to operation of a business system.

Data is raw in form and meaning. It simply exists in isolation and has no significance beyond its existence. It can exist in any form, usable or not. It does not have meaning of itself. In an informational business system, a spreadsheet generally starts out by holding data in each of its cells. In a physical business system, examples of data may include ‘daily sales figures’, ‘weekly production level of a machine shop’, ‘manpower count of a department’, etc.

Information is created as data progresses along its value chain. Information acquires its ‘meaning’ by way of relational connection between constituent data sets. In an informational business system, a relational database holds information based on the data stored within it. In this example, the information contained in the relational database derives its meaning from the numerous data sets and their interrelationships. In a physical business system, a ‘balance sheet’ or a ‘profit and loss account’ or ‘monthly inventory level chart’ are examples of information derived from isolated data on sales, profit, cost, etc.

Knowledge is an appropriate collection of information such that its intent is to be useful. Knowledge is a deterministic body of information organized synergistically and knowledge has useful meaning in its relevant context and system. At the same time, knowledge is a static entity on its own and there is no scope of new knowledge to be generated from an existing body of knowledge. In an informational business system, most of the applications used in business systems, e.g. modeling, simulation, etc. are built around some type of stored knowledge. In a physical business system, an annual report, a process control chart, a ‘quality’ document etc. are examples of knowledge derived from synthesis of information. In other business systems, other knowledge capture systems such as a process trigger, an interview format, a CTQ flow down model, a fishbone diagram, a molecule map graphically representing information and decision flow requirements may be used.

Comprehension is an interpolative and probabilistic process. It is cognitive and analytical. It is the process by which new knowledge input in a system is synthesized with previously held knowledge to generate additional knowledge. The difference between comprehension and knowledge is the difference between ‘learning’ and ‘memorizing’. Business systems endowed with power of comprehension can undertake useful actions because they can synthesize new knowledge, or at least new information, from what is previously known and internalized. In other words, comprehension can build upon currently held information, knowledge and comprehension itself. In an informational business system, artificial intelligence systems possess comprehension in the sense that they are able to synthesize new knowledge from previously stored information and knowledge. In the context of a physical business system, a strategy document, a vision statement, a business process reengineering plan etc. are examples of comprehension as obtained by internalizing and synergizing information.

In an informational model, raw information enters into a business system as data and leaves as processed information or knowledge or comprehension. A process consists of a number of steps executed in a predefined order. Each process step is thus associated with one set of input information that has relatively low value and another set of specific information as output. The process steps add value to the input information to produce the finished information as output. In an information flow environment, the input to each process step is information or data, the process step is typically a decision and the output is a new piece of information resulting from the decisioning. The process is intended to ensure that at each process step, the required input is available and that the output in turn is routed to those process steps that require it as an input. The embodiments may include methods and systems that convert an information matrix into a workflow. The information matrix specifies the required information inputs and produced information outputs for each process step. Thus, the system and the method of this invention are driven directly by information availability, information usage and information dependencies of the business system.

A value chain of a fundamental organizational object is meaningful in a business context only when the end of the value chain is closely aligned with the business goal of a business system. This same principle applies for an information value chain as well. It should be appreciated that knowledge about different information usage and information dependencies of a business system is the basic force that drives any decision making exercise. However, information usage and information dependencies as mentioned in this embodiment are not about the whole range of information available to a business system and its operations, but only the information relevant to the business goals of a business system. For instance, any information regarding the physical composition of the products of a business system may be linked with the business system, but may not be relevant to the business goal, for instance, higher profitability in a financial year. So this information is not fit to be considered for decision making. In other words, information usage, as the driving force for decision making, has to relate to the goals and objectives of the decisions. Processes, sub-processes and functions of a business system should ideally help to achieve these goals and objectives.

A financing decision for a specific ‘deal’ in an asset financing business will be discussed as an example of a business systems and process structured around information usage and information dependencies. To elaborate, an asset financing business takes a customer's financial information, asset information, proposed structure of financing and other information to arrive at a yes/no decision as to financing a specific deal. In that context, a deal signifies a transaction that requires a set of available initial information to be processed and a set of output decision information. For example, a fruit vendor aged 35 years with 10 years' prior experience based in a semi-urban area and applying for a business expansion credit utilizing fruit processing equipment may constitute one deal for a financing agency. And whether to finance him or not is an outcome of the asset financing decision. In the process of arriving at the final decision, various process steps such as legal assessments, risk assessments, asset valuations etc. need to be performed.

The final test of acceptance of an information based model as a viable alternative to a product or service based model is its ability to arrive at a tangible action plan, such as a traditional workflow. As will be appreciated by those skilled in the art, traditional techniques for representing information workflow based on product or service value chains typically start by defining a process hierarchy that depicts an existing business process. By choosing this approach, the business may only make incremental process changes that typically have a low cost and also a low benefit. In addition, there may be an increased use of resources associated with the software implementation of representing such workflows when a software vendor or service provider attempts to incorporate unnecessary or inefficient existing process steps into their solution. Another drawback with traditional workflow generation methods is that the solution provided by the workflow may not provide sufficient flexibility to meet the changing demands of the business, thereby forcing the business to modify its processes to accommodate the already encoded processes in the traditional workflow generation methods. Most often, the changing nature of the dependencies between input and output entities are not addressed in traditional workflow generation method. In short, such traditional workflows are not lean, parallelized and operationalized. An information centric model thus represents a new approach to processes and a new form for workflows that are generated based on the information based process steps discussed earlier. These workflows can more effectively be parallelized and operationalized.

In a traditional workflow generation system, information usage and information dependencies and information output of different process steps are not easily shared. So the workflows often tend to become predominantly sequential. As a contrast, in an information intensive process, a number of process steps can be executed in parallel because information usage and information dependencies and information output can be shared across different process steps easily and widely supported by electronic interactions in a digitized framework. Such process steps may be termed as ‘parallelized’ process steps. Furthermore, these electronic interactions eliminate any need of close physical presence of the interacting objects or a similar need for the objects to be present at the same time or in the same time-zone or any such other traditional restrictions. The easy-to-share and easy-to-replicate nature of information as a resource makes it easy to arrive at a parallelized workflow and then operationalize it.

Once a workflow is parallelized, it needs to be operationalized so that the workflow is easy to implement and easy to operate. Operationlization of a workflow is accomplished by inserting controlling parameters like routing rules, business logic, etc. into the optimization logic of the workflow. The decision making team and the process owners may work together to operationalize processes in a business system. At this stage, much of the planning goes into detailing a set of structured process steps to enable transitioning from a parallelized workflow state to a operationalized state in a phased approach. Typically, process owners themselves may be able to coordinate organization-wide change management activities, as they are aware of the differences between current practices and newly designed processes. When implemented, the resulting operationalized process supports business goals and meets customer expectations. The resulting process is also fast, focused and flexible.

Creation of an information based framework as described above may involve: defining the information usage and information dependencies; developing workflow specifying the routing rules, business rules, and various authority levels of access and execution; and at the end implementing and testing of the workflow. Deploying an information based framework also includes the steps of business requirement gathering to develop a functioning workflow system.

Because of the ever-evolving nature of information as a resource, it is subject to frequent changes. When the context and content of a workflow design changes, the business may want to change the workflow to accommodate the changing information usage and information dependencies, marketplace changes or changing business policies. This traditionally requires rework causing significant costs and time delays. This can be avoided by dynamic updating of workflows as and when the information changes. Moreover, many real life processes may not be easily digitized and traditional workflow generation methods typically change the process to fit the digitization requirement. In an information based framework however, the workflows are much more flexible and they directly relate to the process steps. Therefore, information based workflows tend to be more accurate in representing the business processes.

Instead of merely digitizing process steps to improve them, the information based systems model and represent actual processes realistically and are responsive to frequent changes in any information requirements or usage. Workflows derived and executed directly from the information usage and dependencies in a business system capture the dynamic nature of the business system. Information technology can enable such dynamic workflows. This becomes possible because appropriate use of information technology either eliminates or works around many assumptions that are inherent in traditional workflow processes. Many of these assumptions have existed since long before the advent of modern computer and information technology and no longer hold true. Eliminating these assumptions gives rise to parallelization, many-to-one or one-to-many or many-to-many transactions, instantaneous information updates, and easy and multiple replication of data. One typical example of a one-to-many transaction is one person emailing information to many recipients at the same time. An example of a many-to-one transaction is having a personal web page where data from different web sites are collected and displayed at the same time.

In accordance with one embodiment, the first step of a decision making exercise is determining information usage and information dependencies of a business system. Determining information usage and dependencies starts with identifying a set of high level and core process steps of the business system. As part of the determining step, several approaches may be used for determining information usage and dependencies of a business system. For each major activity with the disclosed methodology, a comprehensive list of process steps are created. The list is captured on an information matrix, such as an MS-Excel spreadsheet, and arranged according to a process flow that the business system is observed to follow.

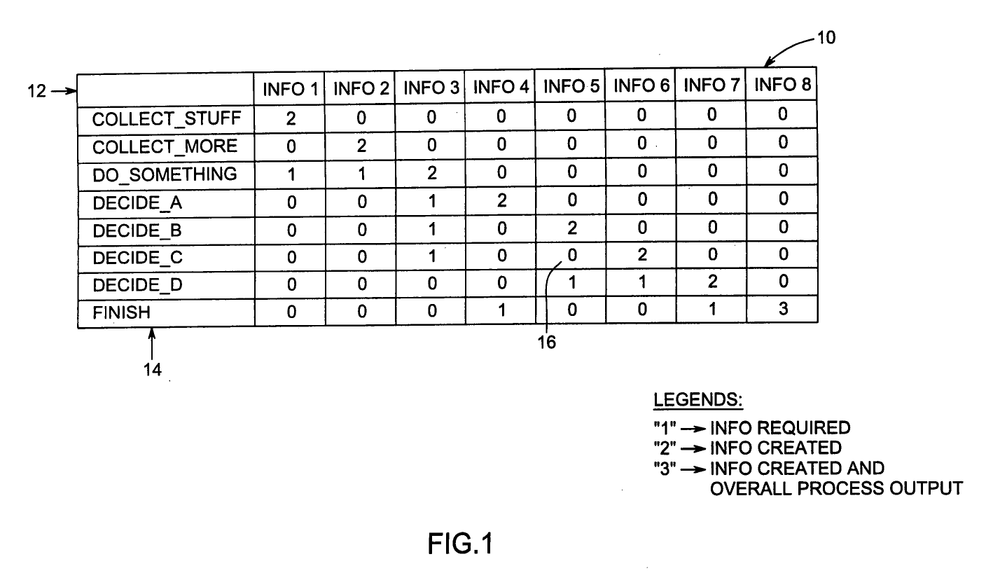

FIG. 1 shows a decision information matrix (DIM) 10, which is explained in an exemplary embodiment of this invention. The decision information matrix 10 is shown the way it appears after the information usage and dependencies of a business system are mapped. There is an exemplary column 12, an exemplary row 14 and an exemplary cell 16. Each of the rows represents a step or a decision of a process or a function of a business system. The rows are the entities that lead this information based model. Each of the columns represent a piece of information that is related to the process steps. These process steps are arrived at from the standardized information collected using different knowledge capture tools.

Once the process steps are identified, the next step of the decision making method in accordance with one embodiment is displaying the information usage and dependencies determined in the previous step as described above. The objective of displaying is to bring out clearly and visually all the inherent and non-obvious relationships and dependencies between different sets of inputs and outputs. The decision information matrix 10 lists all process steps such as ‘collect stuff’, ‘collect more’ . . . ‘finish’ in the rows and specifies for each process step the required information as well as the information pieces such as ‘info 1’, ‘info 2’, . . . ‘info 8’. The rows are the leading entities in the information matrix structure and they signify process steps. The cells along a row represent the type or category of information related to the input requirement and output associated with the process step. Each cell is populated by a coded numeric character.

Referring back to FIG. 1 again, each of the cells in FIG. 1 displays the modes of information processing related to the relevant row and the relevant column. For example, in this embodiment, there are three different modes of information processing represented in the decision information matrix 10—a numeric 0 signifying ‘does not need that information’, a numeric 1 signifying ‘information required’, a numeric 2 signifying ‘information produced’ and a numeric 3 signifying ‘information produced is final output information’. As illustrated in FIG. 1, the cell 16 of the decision information matrix 10 is shown with a numeric 0. This means that the process step ‘decide_C’ does not need ‘info 5’. In a similar manner, the cell at the intersection of the row corresponding to ‘decide_d’ and the column corresponding to ‘info_5’ is shown with a numeric 1. That signifies that the step decide_d requires info_5 for execution. In another instance, the process step ‘collect stuff’ does not require any information and produces ‘info 1’. In this step, information is only collected. On the other hand, ‘Do something’ requires ‘info 1’ and ‘info 2’ and it produces ‘info 3’. Therefore, this would be a typical decision or an evaluation step. At the end of the process, ‘Finish’ requires ‘info 4’ and ‘info 7’and produces ‘info 8’, which is also the required output of the process. The method of reading or interpreting the decision information matrix 10 is to begin with a row, then to check the cells horizontally in sequence and then to determine the backward dependencies, the information processed and the information generated till the last cell is read. The reader or interpreter has to go to the next row to understand the next process step.

The coding in the DIM is not limited to the above-described numeric codes to represent information related to the input requirements and output associated with each process step. In another embodiment of the invention, information usage and information dependencies are displayed using various other display modes such as color codes, hatching patterns, or such other identifying techniques as are known in the art to highlight and distinguish different information contained in the rows, columns and cells of the decision information matrix 10. A process step derives its contextual meaning from the interpretation of the display mode associated with its cells and the column corresponding to the cell. This is explained in more details below.

Traditionally, it has been assumed that digitizing a workflow was sufficient to make it effective. However digitization is meaningful only when it manages information in an effective, goal driven way. Merely digitizing the process steps and workflows in a product/service value chain does not effectively parallelize the decision making methods. By structuring processes around the information value chain, parallelization can be achieved.

Typically, many businesses need to manage information and make decisions that create new information that feeds into further decisions in order to arrive at a final decision. In order to make a process efficient as opposed to being effective, these processes typically utilize information technology that manage information and workflow as well as other attributes such as access rights, data privacy etc. In short, present business thoughts in accordance with one embodiment of the invention have two central themes. One theme is related to efficiency signified by information technology and the other one is effectiveness of the business system made possible by parallelization of workflows.

The set of principles presented above drive deeper the need of mapping the information usage first by dependencies and then sharing the mapped information across a business system. As mentioned earlier, effective workflows are converted from the mapping of information and the relationships captured therein. This conversion is implicit and inherent in the logic of information mapping itself. Decision making does not start with digitization, but starts with information usage and information dependencies mapping. There are frequent changes in the information maps and the ability to execute a workflow based on the information matrix enables the executed workflows to adapt to these changes in real-time. When workflows are created and executed in this way, because of ever changing nature of information, the relationships between input and output constantly change and it is not necessary, or even desirable, to hard-code or predetermine the steps of a process. The dynamic nature of the information model also forebodes that the changes in the execution of workflows will be instantaneous (within the limitations of processing speeds) in response to changes in any dependency structure of input and output parameters defined in the decision information matrix. This way, there is no background processing and response lag in the conversion. The conversion is real time, instantaneous and on-the-fly. The conversion is also subject to availability and necessity of information at any instant of time. Effective digitization sets a robust information technology framework to make this possible and thereby makes frequent redesign of the same framework obsolete.

In essence, decision making as explained above requires taking a broader view of both information technology and business decisions. This view thrives on the relationship between information technology and business decisions in a transactional business system. According to this embodiment of the invention, information technology should be viewed as more than an automating or mechanizing force. The all-pervading power of information technology is used to reshape the fundamental ways of making decisions.

In a similar manner, to maximize their effectiveness, business decisions should be viewed as more than a collection of individual or even functional tasks in a process view. Information technology and decision making have a recursive relationship. Information technology capabilities usually support business processes and business processes need to be enhanced over existing features with the help of capabilities that information technology can provide, such as instantaneous transmission of data, enormous storage capacity, one-to-many and many-to-one transactions and the like. Business processes enhanced by harnessing the enabling power of information technology represent a new approach to coordination across a business system. The impact of information technology make it a powerful tool for achieving dynamic workflows for coordination and parallelization and operationalization of process steps.

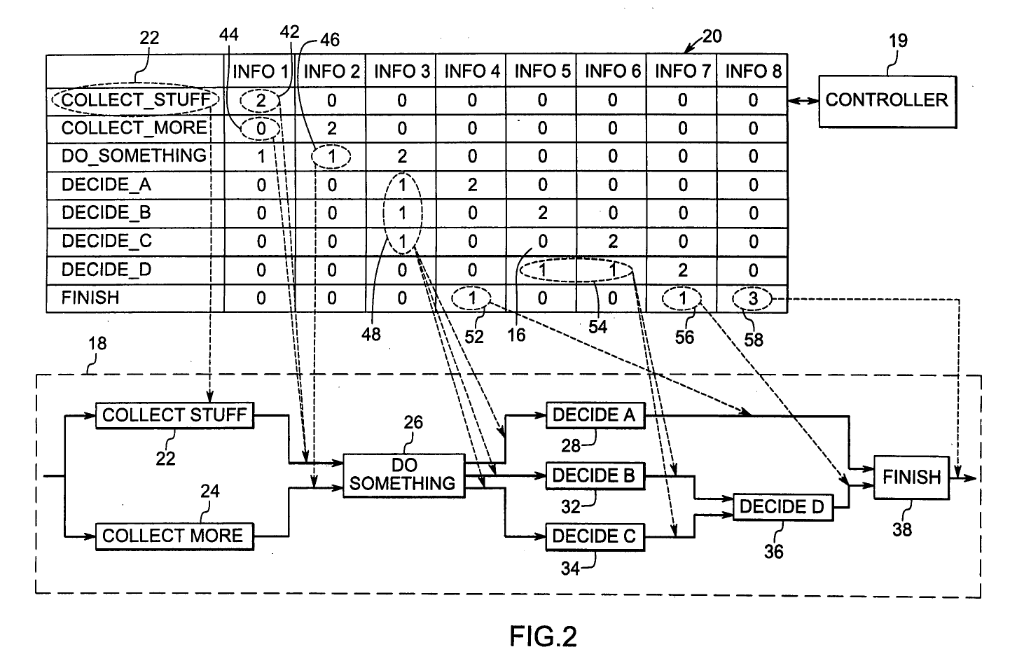

All the power of the information technology discussed above is deployed to convert the relationship and dependencies of process steps into an actionable workflow of an information based business model. Once the information usage and dependencies are captured in a decision information matrix 10 of FIG. 1, the next step is to generate an action plan in the form of a workflow. FIG. 2 is a simplified schematic diagram of an exemplary system according to one embodiment of the invention for generating workflow from an instance of a decision information matrix 20. The system of FIG. 2 is enhanced over the system of FIG. 1 by the addition of a workflow 18 and a controller 19. Moreover, the process steps in workflow 18 (‘collect_stuff’ 22, ‘collect_more’ 24, ‘do_someting’ 26, ‘decide A’ 28, ‘decide B’ 32, ‘decide C’ 34, ‘decide D’ 36 and ‘Finish’ 38) correspond to the process steps of DIM 10. FIG. 2 also shows requirement link for first process step 42, requirement link for second process step 44, requirement link for third process step 46, requirement link for fourth process step 48, requirement link for fifth process step 52, requirement link for sixth process step 54, requirement link for seventh process step 56 and requirement link for eighth process step 58. Components in the system of in FIG. 2 that are identical to the components of the system in FIG. 1 are identified using the same reference numerals.

Processing a deal starts with identifying a row signifying a process step of the deal. Moving horizontally along the row, all the cells are taken up one by one for scrutiny of the category of information they represent. Using the standard notations presented above, any 0 is taken to signify that the information corresponding to that cell is not needed to start that process step. Similarly, a numeric 1 signifies that the relevant information is required for executing that process step; a numeric 2 signifies that the relevant information is produced; and a numeric 3 signifies that the relevant information produced is output information of the overall process. A process step with a 2 in one of the cells and 0s in all the other cells signify a step that does not need any prior information to get executed and produces one or more output information denoted by the numeric 2. One such process step naturally becomes the first step of the workflow under construction. In another embodiment of the invention, the first process step(s) may not have any input information requirements as in many real life situations the entities being processed may enter a process with some information already present. Next, a second process step is linked to the first process step just described such that the output (denoted by 2) of the first step is the input information (denoted by 1) of the second process step. Thus all the process steps are linked to each other following the dependency structure indicated by the numeric characters 0, 1, 2 or 3.

The controller 19 processes a deal based on the information contained in a typical decision information matrix 20 of FIG. 2 as elaborated above giving an output information related to the deal. In one embodiment of the invention, if the processing done by controller 19 is captured conceptually using standard process flow charts, it would look like a workflow 18 shown in FIG. 2. The workflow 18 parallelizes as much work as possible and is thus the fastest one possible. The controller essentially achieves this most parallel workflow without actually implementing it directly. It compares for each deal being processed the available information with the Decision Information Matrix. Each process step for which all required input information is available and output information is missing may be activated. Thus, collect stuff and collect more, which have no input information requirement can be activated directly. Once info 1 and info 2 are available, which are produced by collect stuff and collect more respectively, do something can be activated. Once do something has been completed and thus info 3 is produced, decide A, decide B and decide C can all be activated in parallel as for each one of those the required input information is available. Once decide B and decide C are done, info 5 and info 6 are available, the information requirement for decide D is fulfilled and it can be activated. Finish requires info 7, which is produced by decide D, and info 4, which is produced by decide A. Thus, once Decide A and Decide D are completed, process step Finish can be activated. Thereby, using the relatively simple and flexible logic described the same parallel workflow is achieved. The structure of the workflow 18 and therefore the level of parallelism is strictly driven by the information contained in the Decision Information matrix 20. There is no pre-decided and hard-coded workflow. Rather, the system maintains a list of the available information for each item and compares it to the information usage and information dependencies as defined by decision information matrix 20 whenever any change occurs to an item or entity that is being processed such as on entering the process or on the completion of any process step.

The invention is not limited to the above-described configuration of the controller 19. In other embodiments of the invention, the controller 19 may include other solid-state equipments, relays, microprocessors, software, hardware, firmware, etc. or combinations thereof. A number of switches, gates and visual signals may be part of the logic circuitry of the controller 19.

In another embodiment of the controller 19, it detects and corrects logical mistakes such as circular dependencies or information that is required and never produced or products and services never required. Moreover, the controller 19 automatically implements the most parallelized workflow. The controller 19 also eliminates any hard coding of workflow thereby saving time and cost and reducing mistakes from workflow creation projects. The controller 19 further allows updating of the executed workflows by simply changing the decision information matrix 20. Because there is no need to translate the decision information matrix into a specific hard-coded workflow, the change is propagated into the execution of any deal in process virtually instantaneously and at reduced cost. This data driven approach gives the business maximum flexibility to react to changing business realities.

In yet another embodiment of the invention, the conversion of the decision information matrix 10 into a workflow 18 is automatic. In yet another embodiment of the invention, the processing of the deal by the controller 19 may be triggered by an external agency such as a customer or a decision maker. In such a scenario, the controller 19 also evaluates whether the decision information matrix 20 and all the process steps enumerated in the rows are necessary to work out the workflow 19. In yet another embodiment of the invention, the controller 19 also evaluates whether the decision information matrix and the process steps are factually valid at any instant of operation. In this instance, the controller 19 performs backward evaluation of validity of the process steps. The controller 19 further evaluates whether any particular information is available and whether past dependency of one process step on another process step has gone through any change. In yet another embodiment of the invention, the controller 19 converts the decision information matrix into a workflow based on certain conditions and external decision parameters such as the size of a deal, a process owner's preferences and the like. In one further embodiment of the invention, the controller 19 continuously reviews not only the availability of information against the decision information matrix 20, but also the necessity of information.

According to another embodiment of the invention, one method starts from the end of the information capture and converting steps, and a parallelized workflow is obtained based on the dependencies from different process steps. Such a parallelized workflow depicts the flow of work that is currently performed by the business in course of making a decision and it documents interactions between different process steps.

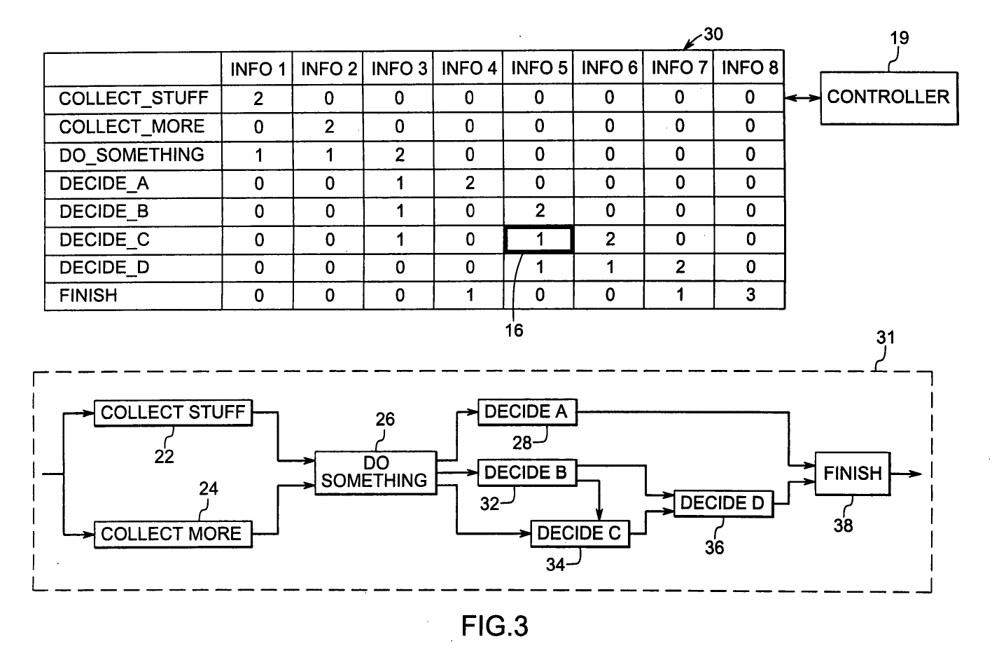

FIG. 3 shows another instance of a workflow 31 generated from a revised decision information matrix 30. As with workflow 18 in FIG. 2, workflow 31 is the effective workflow being executed, rather than a formal, hard-coded workflow. FIG. 3 is a simplified schematic diagram of an exemplary system 20 for generating workflow from a decision information matrix 10. Other than the dependency of process step Decide_C 34, the DIM 30 in FIG. 3 is substantially similar to DIM 20 shown in FIG. 2. Components in FIG. 3 are identical to components in FIG. 2 and so the same reference numerals are used in FIG. 3. The content of the cell 16 in the decision information matrix 30 of FIG. 3 has changed from 0 in the decision information matrix 20 of the previous embodiment of FIG. 2 to 1. That signifies a change in the dependency of the process step decide_c on information category info_5.

The controller 19 processes a deal based on the information contained in a typical decision information matrix 30 of FIG. 3 as elaborated above giving an output information related to the deal. In this embodiment of the invention, if the processing done by controller 19 is captured conceptually using standard process flow charts, it would look like a workflow 31 shown in FIG. 3. In this instance, the information contained in cell 16 has changed from a 0 in FIG. 2 to a 1 in FIG. 3. Thus, Decide_C now requires info 5 as input information and consequently cannot be executed until Decide B, which produces info 5, has been completed. Decide B and Decide C are no longer parallel decisions. The described logic of the controller will simply interpret the changed decision information matrix without any recoding. The actual execution will follow the workflow 31 laid out in FIG. 3.

The system of FIG. 3 illustrates that while generating workflows, different decision criteria may be used in different embodiments of the invention. One such decision criterion, in accordance with one embodiment, is to achieve the objectives by continuously updating the dependencies and the workflows. Thus, by using the controller 19 and the decision information matrix 30 for the business the invention eliminates a large part of the information technology work that is traditionally used to do similar updating. This use of an information technology framework makes the function of workflow generation instantaneous and explicit. In a traditional business system, any elimination of rework typically reduces months off a process design or redesign project. For instance, changes in an existing decision information matrix 20 of FIG. 2 to a revised decision information matrix 30 of FIG. 3 such as change in its cell values or addition of new columns and/or rows are implemented simply by replacing the existing decision information matrix 10 with a new updated one.

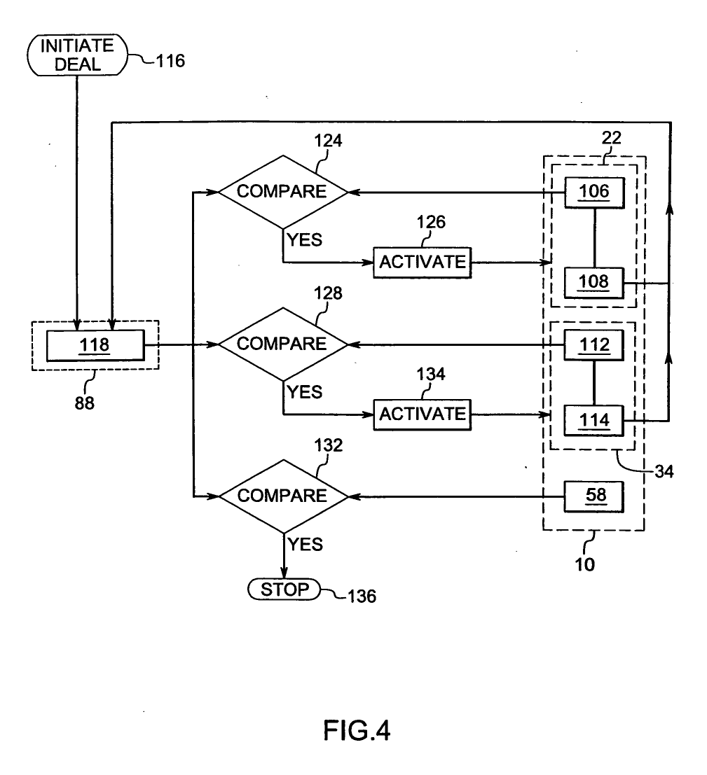

FIG. 4 shows an exemplary flow chart of a decision making method 40 as is explained in an exemplary embodiment of this invention. The Decision Information Matrix describes for each process step the information requirements and output information. Two exemplary process steps 22 and 34 are shown in FIG. 4. As shown in the Figure, every process step in the workflow includes two structural elements—information usage and information dependencies; and information output associated with the process step. Thus, information requirement 106 and information output 108 are associated with the process step 22. In a like manner, information requirement 112 and information output 114 are associated with the process step 34. Both process steps are part of the Decision Information Matrix. The exemplary workflow of FIG. 4 includes two steps, each corresponding to one row of a Decision Information Matrix. It will be understood that the appropriate process for a given Decision Information Matrix will require as many ‘compare’ steps (e.g., 124, 128) as there are rows in the Decision Information Matrix. Each compare step will also require the associated steps and elements referenced as 126, 22, 106 and 108, and discussed further below.

The process starts with a deal 88 being initiated as in functional block 116. The deal 88 includes a set of available initial information 118. The available initial information 118 of deal is compared with the information requirement 106 associated with the first process step 22 as in functional block 124. If the information requirement 106 associated with the first process step 22 is included in the set of available initial information 118, the process step 22 is activated as in functional block 126 and allowed to proceed for completion. Once the step 22 is executed, output information 108 is received from the activated process step 22 and added to the deal information 118. In parallel the same happens with process step 34. The available information 118 is compared to the required information 112 and if all required information is included in the available information process step 34 is activated. If for either process step the comparison of available information 118 to required information 106 or 112 fails, the test is repeated periodically and upon any changes to the available information 118. Separately a test 132 is executed upon each change in the available information 118 that determines whether the required process overall output 58 is part of the available information 118. If this test passed the process is stopped.

A more complete and balanced view of the role of information technology or digitization appears when the method of FIG. 4 is implemented. It is evident at the end of a decision making process, that by its framework, information technology is instrumental in reducing the degree of mediation and enhancing the degree of collaboration between different process steps. Moreover, innovative uses of information technology in most of the cases would lead many business systems to develop new, coordination-intensive structures. These coordination-intensive structures enable traditional business systems to coordinate their activities in ways that were not possible before dynamic workflows are generated. Such coordination-intensive structures may also raise the capabilities and responsiveness business system, leading to potential strategic advantages.

The exemplary system illustrated in relation to various embodiments above belongs to a finanancial system, specifically, a transactional business system. Another example of a physical process that can be dynamically managed using digitization is a just-in-time supply chain management process. In an information mapped process, workflows automatically update related inventory data and the sourcing function and the suppliers can be contacted as soon as the level of inventories fall below specified reorder points. A similar example of an informational process may be an asset financing decision a bank may be evaluating about its customers. In a dynamic workflow form, news alerts about new share options are automatically sent to the mailboxes of the customers, they are encouraged to work out their own portfolio by online computations and finally after a number of intermediate steps, the monetary value is transferred directly from or to the online account of the participating customers of the bank. The primary objective always is to check the final outcome of the decisions.

The method of decision making as exemplified in this embodiment is practiced to make deal decisions in a financial system. The method of decision making as exemplified herein helps identify what information is needed by different functions in a process, for example credit, sourcing, pricing, finance, etc. and the level of effort needed to get this information. The overall process is mapped in workflows such that all necessary information is obtained once at the beginning of the process and then made digitally available to different functions in parallel to reduce cycle time to arrive at a yes/no decision.

The techniques described herein are not limited to the above example of a transactional business system and can be used in any transactional business systems e.g. insurance processes, quotation processes, etc. In other embodiments, non-transactional business systems can also be reengineered following the method of business process engineering described above. Examples of such non-transactional business systems include traditional manufacturing processes and many other system diagnosis or maintenance processes. Moreover, digitization is not a mandatory element of the decision making method described here. There are other embodiments, where a manual process or a semi-digitized workflows are generated using the same approach.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A method for decision making based on information requirements of a business system comprising:
reading a decision information matrix comprising:
at least one process step related to a process of said business system;
input information requirements associated with each of said at least one process step;
processing a deal, said deal comprising a set of available information;
comparing said available information associated with said deal to said input information requirements associated with said at least one process step;
activating said at least one process step if said input information requirements associated with said at least one process step are included in said available information related to said deal;
receiving output information from each of said at least one activated process step;
adding said output information to the set of available information of the deal;
evaluating if a final output information for said deal has been received;
continuing to compare and activate process steps as appropriate based on said available information.

2. The method according to claim 1, wherein said input information requirements comprise dynamic input information requirements.

3. The method according to claim 1, wherein said processing a deal comprises processing an externally initiated deal.

4. The method according to claim 1, wherein said processing comprises implicit processing.

5. The method according to claim 1, wherein said processing comprises instantaneous processing.

6. The method according to claim 1, wherein said processing comprises evaluating whether said decision information matrix and said at least one process step are necessary.

7. The method according to claim 1, wherein said processing comprises evaluating whether said decision information matrix and said at least one process step are valid.

8. The method according to claim 7, wherein said processing comprises backward evaluation of validity of said at least one process step.

9. The method according to claim 1, wherein said processing comprises evaluating whether said information related to said information requirement is available.

10. The method according to claim 1, wherein said processing comprises evaluation of dependency of said at least one process step on at least one element selected from a group consisting of another process step, an information requirement, and any combination thereof.

11. The method according to claim 1, wherein said processing comprises evaluation of logical flaws in said at least one process step.

12. The method according to claim 1, wherein said activating comprises deactivating said at least one process step when said at least one process step is invalid.

13. The method according to claim 1, wherein said processing comprises conditional processing based on a predetermined external parameter.

14. The method according to claim 13, wherein said external parameter comprises at least one element selected from a group consisting of size of said deal, an owner of said at least one process step, and any combination thereof.

15. The method according to claim 1, wherein said reading comprises:
reading said information in at least one row and at least one column of said decision information matrix; and
reading said information in at least one cell of said decision information matrix.

16. The method according to claim 15, wherein said information in said at least one row comprises information related to a process step.

17. The method according to claim 15, wherein said information in said at least one column comprises information related to type of said information.

18. The method according to claim 17, wherein said type of said information comprises at least one element selected from a group consisting of input information, output information, and any combination thereof.

19. The method according to claim 15, wherein said information in said at least one cell comprises information related to a type of said information required by said process step.

20. A system for decision making based on information requirements of a business system comprising:
a decision information matrix to represent said information requirements;
at least one deal comprising a set of available information to be processed; and
a controller to process said at least one deal based on said available information and said information requirements and generate at least one output information associated with said at least one deal.

21. The system according to claim 20, wherein said decision information matrix comprises:
at least one row;
at least one column; and
at least one cell formed by an intersection of said at least one row and said at least one column.

22. The system according to claim 21, wherein said at least one row comprises information related to a process step.

23. The system according to claim 21, wherein said at least one column comprises information related to type of said information.

24. The system according to claim 23, wherein said type of information comprises at least one element selected from a group consisting of input information, output information, and any combination thereof.

25. The system according to claim 21, wherein said at least one cell comprises information related to a category of said information required by said process step.

26. The system according to claim 25, wherein said category of said information comprises at least one element selected from a group consisting of information required, information created, overall process output, and any combination thereof.

27. The system according to claim 20, wherein said input information requirements comprises dynamic input information requirements.

28. A business system framework, comprising:
multiple interrelated business processes for accomplishing a business objective, wherein each of said interrelated business processes includes a plurality of information requirements;
a decision information matrix to represent said information requirements;
at least one deal comprising a set of available information to be processed; and
a controller to process said at least one deal based on said available information and said information requirements implicitly and generate at least one output information associated with said at least one deal.
